(19) United States
(12) Patent Application Publication
(10) Pub. No.: US 2019/0333161 A1
(43) Pub. Date: Oct. 31, 2019

(54) RECOMMENDING ACTIONS FOR PHOTOS

(71) Applicant: Google Inc., Mountain View, CA (US)

(72) Inventors: Erik Murphy-Chutorian, Palo Alto, CA (US); Matthew Steiner, Los Altos, CA (US); Peter Sorotokin, San Jose, CA (US)

(73) Assignee: Google Inc., Mountain View, CA (US)

(21) Appl. No.: 14/326,410

(22) Filed: Jul. 8, 2014

(51) Int. Cl. G06Q 50/00; G06F 17/30

(52) U.S. Cl. CPC G06Q 50/01; G06F 17/30256

(57) ABSTRACT

Implementations generally relate to providing recommended actions for photos. In some implementations, a method includes obtaining activity data associated with one or more actions of a performing user, wherein the activity data involves at least one first photo. The method further includes performing or suggesting one or more actions to one or more second photos based on one or more predetermined similarity criteria.

### BACKGROUND

Social network systems often enable users to upload media content such as photos, and enable users to create photo albums. Social network systems also enable users to share photos with each other. For example, users can share photos with friends and family, which provides enjoyable and bonding experiences among users of a social network system.

### SUMMARY

Implementations generally relate to providing recommended actions for photos. In some implementations, a method includes obtaining activity data associated with one or more actions of a performing user, where the activity data involves at least one first photo. The method further includes performing or suggesting one or more actions to one or more second photos based on one or more predetermined similarity criteria.

With further regard to the method, in some implementations, the activity data is historical activity data. In some implementations, the activity data includes sharing the at least one first photo. In some implementations, the activity data includes posting the at least one first photo. In some implementations, the activity data includes adding the at least one first photo to a photo album. In some implementations, at least one of the one or more actions includes recommending that the performing user share the one or more second photos. In some implementations, at least one of the one or more actions includes adding the one or more second photos to a photo album. In some implementations, the predetermined similarity criteria includes a determination of visual similarity between the one or more second photos and the at least one first photo. In some implementations, the predetermined similarity criteria includes a determination of categorical similarity between the one or more second photos and the at least one first photo. In some implementations, the method further includes predicting a desired action of the performing user based on the activity data.

In some implementations, a method includes obtaining activity data associated with one or more actions of a performing user, where the activity data involves at least one first photo, where the activity data is historical activity data, and where the activity data includes sharing the at least one first photo. The method further includes performing or suggesting one or more actions to one or more second photos based on one or more predetermined similarity criteria, where the predetermined similarity criteria includes a determination of visual similarity between the one or more second photos and the at least one first photo.

With further regard to the method, in some implementations, at least one of the one or more actions includes recommending that the performing user share the one or more second photos. In some implementations, at least one of the one or more actions includes adding the one or more second photos to a photo album. In some implementations, the method further includes predicting a desired action of the performing user based on the activity data.

In some implementations, a system includes one or more processors, and logic encoded in one or more tangible media for execution by the one or more processors. When executed, the logic is operable to perform operations including: obtaining activity data associated with one or more actions of a performing user, where the activity data involves at least one first photo; and performing or suggesting one or more actions to one or more second photos based on one or more predetermined similarity criteria.

With further regard to the system, in some implementations, the activity data is historical activity data. In some implementations, the activity data includes sharing the at least one first photo. In some implementations, the activity data includes posting the at least one first photo. In some implementations, the activity data includes adding the at least one first photo to a photo album. In some implementations, at least one of the one or more actions includes recommending that the performing user share the one or more second photos.

### BRIEF DESCRIPTION OF THE DRAWINGS

FIG. 1 illustrates a block diagram of an example network environment, which may be used to implement the implementations described herein.

FIG. 2 illustrates an example simplified flow diagram for recommending actions associated with photos, according to some implementations.

FIG. 3 illustrates an example simplified block diagram showing actions and recommendations associated with photos, according to some implementations.

FIG. 4 illustrates a block diagram of an example server device, which may be used to implement the implementations described herein.

### DETAILED DESCRIPTION

Implementations described herein provide recommended actions associated with photos. In various implementations, a system obtains activity data associated with one or more actions of a user. For example, the activity data may involve a given first photo. In some implementations, the activity data includes historical activity data associated with that first photo. For example, the activity data may be associated with the user who captured the photo sending particular photos to one or more other users (e.g., one or more family members) in a social network system. Such activity data may also include the user posting particular photos to other users (e.g., to more family members). In some implementations, the activity data may include the user adding particular photos to a photo album (e.g., an existing photo album called “Family Reunion 2013” or a newly created photo album called “Family Reunion 2014”).

The system then performs one or more actions to one or more other photos based on one or more predetermined similarity criteria. Such other photos may include, for example, new photos that the user has taken. In some implementations, at least one of the actions may include the system recommending that the user share the photos or add the photos to a photo album. In some implementations, the predetermined similarity criteria may include a determination of visual similarity between the one or more other photos and the at least one first photo. For example, the system may determine that the photos are of the same person. In some implementations, the predetermined similarity criteria includes a determination of categorical similarity between the one or more second photos and the at least one first photo. For example, the system may determine that the photos are of similar landmarks. In some implementations, the system further predicts a desired action of the performing user based on the activity data. For example, the system may predict that the user would want to share particular photos with particular people.

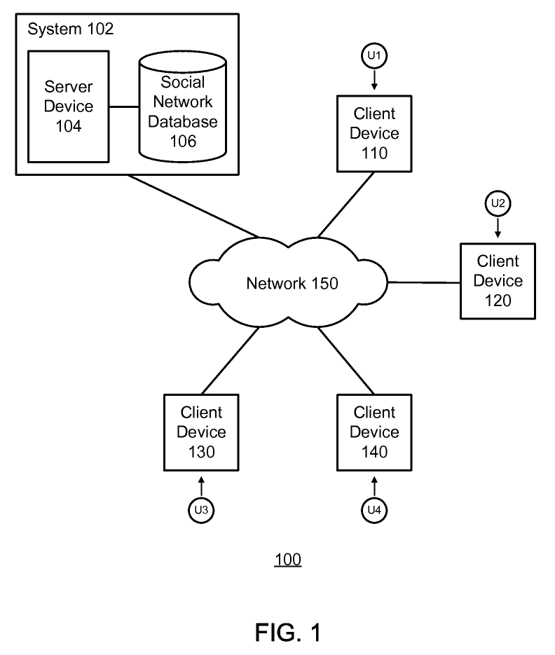

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may share media such as photos with each other, where respective client devices 110, 120, 130, and 140 transmit media to each other.

In the various implementations described herein, the processor of system 102 causes the elements described herein (e.g., photos, recommendations, etc.) to be displayed in a user interface on one or more display screens.

In various implementations, system 102 may utilize a recognition algorithm to detect and/or recognize faces and other objects in photos. Example implementations of recognition algorithms are described in more detail below.

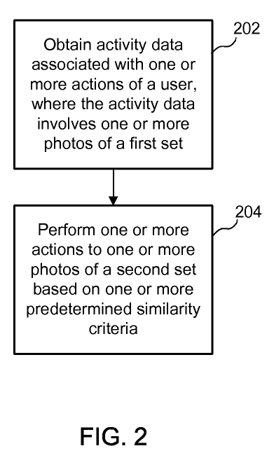

FIG. 2 illustrates an example simplified flow diagram for recommending actions associated with photos, according to some implementations. Referring to both FIGS. 1 and 2, a method is initiated in block 202, where system 102 obtains activity data associated with one or more actions of a user, where the activity data involves one or more photos of a first set.

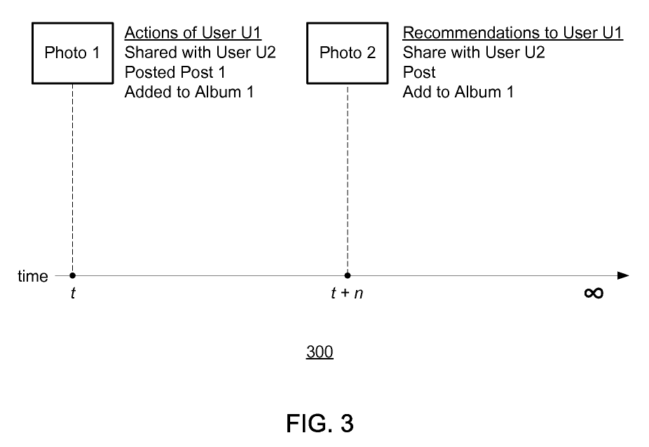

FIG. 3 illustrates an example simplified block diagram showing actions and recommendations associated with photos, according to some implementations. As shown, a user (e.g., user U1) performs one or more actions associated with a photo (e.g., Photo 1). In various implementations, the activity data is historical activity data, where system 102 logs, updates, and aggregates such activity data that the user performed with regard to the photo. For ease of illustration, in various implementations, this user may be referred to as performing user.

The following examples are actions that the performing user might take with regard to a given photo. For ease of illustration, in various implementations, the given photo may be referred to a first photo. Also, for ease of illustration, various example implementations are described in the context of a single, first photo. These implementations and others may also apply to multiple photos. Such photos may be referred to as photos of a first set, or referred to as a set of first photos.

In various implementations, the activity data may include sharing one or more photos of a first set. For example, referring to FIG. 3, system 102 may log that user U1 shared Photo 1 with a particular user (e.g., user U2, etc.). In various implementations, system 102 may log similar actions involving sharing in association with user U1 (and each of the other users) and in association with Photo 1. For example, after receiving Photo 1, user U2 may in turn share Photo 1 with another user (e.g., share with user U3, etc.). In another example, user U1 may, at a future time, share Photo 1 with other users (e.g., share with user U4, etc.).

In some implementations, the activity data may include posting the at least one first photo. For example, still referring to FIG. 3, system 102 may log that user U1 posted Photo 1 on a Post 1 on a social network page associated with user U2. In various implementations, system 102 may log similar actions involving posting in association with user U1 and in association with Photo 1. For example, after receiving Photo 1 or viewing Photo 1 in Post 1, user U2 may in turn post Photo 1 on a social network page associated with user U2. In another example, user U1 may, at a future time, repost Photo 1.

In some implementations, the activity data includes adding the at least one first photo to a photo album. For example, system 102 may log that user U1 added Photo 1 to a particular photo album (e.g., Album 1). In another example, user U1 may, at a future time, add Photo 1 to one or more other photo albums.

Still referring to FIG. 3, the actions of user U1 with regard to Photo 1 are shown as being associated with time t. In actual practice, multiple actions (e.g., sharing a photo with someone, posting the photo, adding the photo to a photo album, etc.) would not occur exactly at the same time but would rather be performed a different time, even if within a small time window (e.g., 5 minutes, etc.). As such, in some implementations, time t may be referred to as a particular time or a time window that occurs before time t+n. As described in more detail below, system 102 may make one or more recommendations at time t+n based on various predetermined similarity criteria.

In block 204 of FIG. 2, system 102 performs or suggests one or more actions to one or more photos of a second set based on one or more predetermined similarity criteria. For example, in various implementations, one or more of the actions may include system 102 recommending that the performing user share one or more photos of the second set. In some implementations, one or more of the actions may include system 102 recommending that the performing user post one or more photos of the second set. In some implementations, one or more of the actions may include system 102 recommending that the performing user add one or more photos of the second set to a particular photo album. In various implementations, system 102 may perform some actions automatically, without a suggestion/recommendation phase. For example, in some implementations, one or more of the actions may include system 102 automatically adding one or more photos of the second set to a particular photo album. Implementations involving these actions are described in more detail below. The following describes predetermined similarity criteria.

While some implementations have been describe in the context of adding a new photo to the same photo album as an older, similar photo, these implementations and others also apply to adding the new photo to another photo album. System 102 may create a new photo album after a predetermined amount of time has passed. For example, instead of adding new photos to a family reunion 2013 photo album, system 102 may add the new photos to a newly created family reunion 2014 photo album.

In various implementations, system 102 predicts one or more desired actions of the performing user based on activity data. For example, system 102 may predict that the user would want to share one or more particular photos with one or more particular people. In another example, system 102 may predict that the user would want to post one or more particular photos. In another example, system 102 may predict that the user would want to add one or more particular photos to one or more particular photo albums. Particular example implementations are described in more detail below.

In various implementations, the predetermined similarity criteria may include a determination of visual similarity between the one or more second photos and the at least one first photo. For example, the system may determine that the photos are of the same person. As such, referring again to FIG. 3, presume based on activity data that system 102 determines that a performing user (e.g., user U1) shared a particular photo (e.g., Photo 1) with a particular user (e.g., user U2). If a subsequent photo (e.g., Photo 2) is determined to meet a predetermined similarity criteria (e.g., both Photo 1 and Photo 2 contain an image of the same person), then system 102 may recommend that the performing user also share Photo 2 with the same particular user (e.g., user U2). In a specific example, Photo 1 and Photo 2 may include an image of user U1's daughter, and user U2 may be user U1's mother (e.g., a mother, user U1, shares a picture of her daughter with the child's grandmother, user U2). As such, because user U1 had previously shared Photo 1 with user U2, the recommendation would be appropriate for user U1 to share with user U2 a new Photo 2 of the same daughter .

As indicated above, in various implementations, system 102 may utilize a recognition algorithm to detect and/or recognize faces and other objects in photos. Example implementations of recognition algorithms are described in more detail below.

In various implementations, the predetermined similarity criteria may include a determination of categorical similarity between the one or more second photos and the at least one first photo. For example, the system may determine that the photos are of landmarks. As such, referring still to FIG. 3, presume based on activity data that system 102 determines that a performing user (e.g., user U1) shared a particular photo (e.g., Photo 1) with a particular user (e.g., user U2). If a subsequent photo (e.g., Photo 2) is determined to meet a predetermined similarity criteria (e.g., both Photo 1 and Photo 2 being of the same category), system 102 may recommend that the performing user also share Photo 2 with the same particular user (e.g., user U2). In a specific example, Photo 1 and Photo 2 may include famous landmarks (e.g., famous buildings). As such, because user U1 had previously shared Photo 1 of a building with user U2, the recommendation for user U1 to share a new Photo 2 of a similar building with user U2 would be appropriate.

In various implementations described herein, system 102 may use machine-learning algorithms (e.g., supervised learning). Such machine-learning algorithms may deal with conflicting and/or incomplete signals, which are inevitable in practice. In various implementations, other signals (e.g., location data, etc.) may be used when applying a machine-learning algorithms. In some implementations, when the number of similarity signals and potential actions is significant, system 102 may use a supervised learning algorithm to collect the necessary historical data and make predictions and this allows usage of other signals.

Implementations described herein provide various benefits. For example, implementations described herein increase overall engagement among users in a social networking environment. Implementations facilitate the sharing of photos among users in a social networking environment.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

In various implementations, system 102 may utilize a variety of recognition algorithms to recognize faces, landmarks, objects, etc. in images. Such recognition algorithms may be integral to system 102. System 102 may also access recognition algorithms provided by software that is external to system 102 and that system 102 accesses.

In various implementations, system 102 enables users of the social network system to specify and/or consent to the use of personal information, which may include system 102 using their faces in images or using their identity information in recognizing people identified in images. For example, system 102 may provide users with multiple selections directed to specifying and/or consenting to the use of personal information. For example, selections with regard to specifying and/or consenting may be associated with individual images, all images, individual photo albums, all photo albums, etc. The selections may be implemented in a variety of ways. For example, system 102 may cause buttons or check boxes to be displayed next to various selections. In some implementations, system 102 enables users of the social network to specify and/or consent to the use of using their images for facial recognition in general. Example implementations for recognizing faces and other objects are described in more detail below.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In various implementations, system 102 obtains reference images of users of the social network system, where each reference image includes an image of a face that is associated with a known user. The user is known, in that system 102 has the user's identity information such as the user's name and other profile information. In some implementations, a reference image may be, for example, a profile image that the user has uploaded. In some implementations, a reference image may be based on a composite of a group of reference images.

In some implementations, to recognize a face in an image, system 102 may compare the face (e.g., image of the face) and match the face to reference images of users of the social network system. Note that the term “face” and the phrase “image of the face” are used interchangeably. For ease of illustration, the recognition of one face is described in some of the example implementations described herein. These implementations may also apply to each face of multiple faces to be recognized.

In some implementations, system 102 may search reference images in order to identify any one or more reference images that are similar to the face in the image. In some implementations, for a given reference image, system 102 may extract features from the image of the face in an image for analysis, and then compare those features to those of one or more reference images. For example, system 102 may analyze the relative position, size, and/or shape of facial features such as eyes, nose, cheekbones, mouth, jaw, etc. In some implementations, system 102 may use data gathered from the analysis to match the face in the image to one more reference images with matching or similar features. In some implementations, system 102 may normalize multiple reference images, and compress face data from those images into a composite representation having information (e.g., facial feature data), and then compare the face in the image to the composite representation for facial recognition.

In some scenarios, the face in the image may be similar to multiple reference images associated with the same user. As such, there would be a high probability that the person associated with the face in the image is the same person associated with the reference images.

In some scenarios, the face in the image may be similar to multiple reference images associated with different users. As such, there would be a moderately high yet decreased probability that the person in the image matches any given person associated with the reference images. To handle such a situation, system 102 may use various types of facial recognition algorithms to narrow the possibilities, ideally down to one best candidate.

For example, in some implementations, to facilitate in facial recognition, system 102 may use geometric facial recognition algorithms, which are based on feature discrimination. System 102 may also use photometric algorithms, which are based on a statistical approach that distills a facial feature into values for comparison. A combination of the geometric and photometric approaches could also be used when comparing the face in the image to one or more references.

Other facial recognition algorithms may be used. For example, system 102 may use facial recognition algorithms that use one or more of principal component analysis, linear discriminate analysis, elastic bunch graph matching, hidden Markov models, and dynamic link matching. It will be appreciated that system 102 may use other known or later developed facial recognition algorithms, techniques, and/or systems.

In some implementations, system 102 may generate an output indicating a likelihood (or probability) that the face in the image matches a given reference image. In some implementations, the output may be represented as a metric (or numerical value) such as a percentage associated with the confidence that the face in the image matches a given reference image. For example, a value of 1.0 may represent 100% confidence of a match. This could occur, for example, when compared images are identical or nearly identical. The value could be lower, for example 0.5 when there is a 50% chance of a match. Other types of outputs are possible. For example, in some implementations, the output may be a confidence score for matching.

For ease of illustration, some example implementations described above have been described in the context of a facial recognition algorithm. Other similar recognition algorithms and/or visual search systems may be used to recognize objects such as landmarks, logos, entities, events, etc. in order to implement implementations described herein.

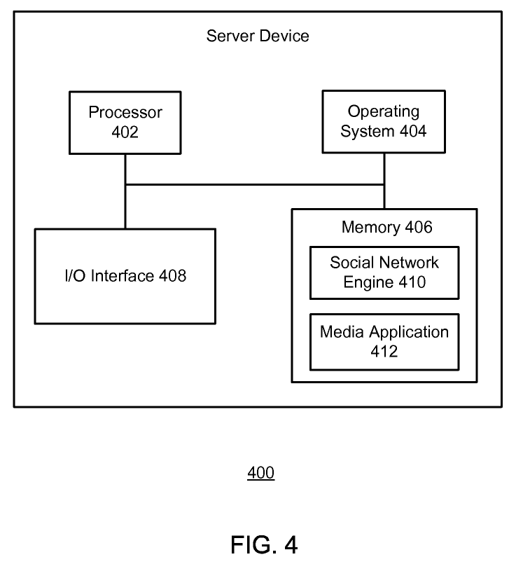

FIG. 4 illustrates a block diagram of an example server device 400, which may be used to implement the implementations described herein. For example, server device 400 may be used to implement server device 104 of FIG. 1, as well as to perform the method implementations described herein. In some implementations, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other implementations, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions for execution by the processor. For example, a tangible medium such as a hardware storage device can be used to store the control logic, which can include executable instructions. The software instructions can also be contained in, and provided as, an electronic signal, for example in the form of software as a service (SaaS) delivered from a server (e.g., a distributed system and/or a cloud computing system).

1. A computer-implemented method comprising:
obtaining historical activity data associated with one or more actions of a performing user, wherein the historical activity data comprises sharing at least one first photo;
using, by one or more processors, a recognition algorithm to identify one or more of a face, a landmark, or an object in each of the at least one first photo and one or more second photos, wherein the recognition algorithm for the face includes one or more of (1) a geometric algorithm that identifies the face by comparing a relative position, size, and shape of facial features in the face to a reference image or (2) a photometric algorithm that uses a statistical approach to distill each of the facial features into values for comparison with the reference image;
generating an output indicating a likelihood that the one or more of the face, the landmark, or the object matches the reference image;
determining a visual similarity between the at least one first photo and the one or more second photos based on the recognition algorithm and the output;
suggesting to add the one or more second photos to a photo album that includes the at least one first photo based on the visual similarity between the one or more second photos and the at least one first photo; and
recommending that the performing user share the one or more second photos.

2. The method of claim 1, wherein the reference image is a profile image of a user associated with a social network.

3. The method of claim 1, further comprising adding the one or more second photos to the photo album.

4. The method of claim 1, further comprising predicting a desired action of the performing user based on the historical activity data and a relationship between the performing user and other users.

5. A computer-implemented method comprising:
obtaining activity data associated with one or more actions of a performing user, wherein the activity data involves at least one first photo;
using, by one or more processors, a recognition algorithm to identify one or more of a face, a landmark, or an object in each of the at least one first photo and one or more second photos, wherein the recognition algorithm for the face includes a geometric algorithm that identifies the face by comparing a relative position, size, and shape of facial features in the face to a reference image and a photometric algorithm that uses a statistical approach to distill each of the facial features into values for comparison with the reference image;
generating an output indicating a likelihood that the one or more of the face, the landmark, or the object matches the reference image;
determining a visual similarity between the at least one first photo and the one or more second photos based on the recognition algorithm and the output; and
performing or suggesting one or more actions to one or more second photos based on the visual similarity between the at least one first photo and the one or more second photos, wherein the one or more actions include recommending that the performing user share the one or more second photos.

6. The method of claim 5, wherein the activity data is historical activity data.

7. The method of claim 5, wherein the activity data comprises sharing the at least one first photo.

8. The method of claim 5, wherein the activity data comprises posting the at least one first photo.

9. The method of claim 5, wherein the activity data comprises adding the at least one first photo to a photo album.

10. The method of claim 5, wherein at least one of the one or more actions comprises recommending that the performing user share the one or more second photos.

11. The method of claim 5, wherein at least one of the one or more actions comprises adding the one or more second photos to a photo album.

12. The method of claim 5, wherein the activity data is historical activity data, the historical activity data includes the performing user sharing the at least one first photo, and the one or more actions include sharing the one or more second photos based on the visual similarity between the at least one first photo and the one or more second photos.

13. The method of claim 5, wherein determining the visual similarity includes a determination of categorical similarity between a second object in the one or more second photos and a first object in the at least one first photo, wherein the first object and the second object are associated with a same category.

14. The method of claim 5, further comprising predicting a desired action of the performing user based on the activity data and a relationship between the performing user and other users.

15. A system comprising:
one or more processors; and
logic encoded in one or more tangible media for execution by the one or more processors and when executed operable to perform operations comprising:
obtaining activity data associated with one or more actions of a performing user, wherein the activity data involves at least one first photo;
using a recognition algorithm to identify one or more of a face, a landmark, or an object in each of the at least one first photo and one or more second photos, wherein the recognition algorithm for the face includes one or more of (1) a geometric algorithm that identifies the face by comparing a relative position, size, and shape of facial features in the face to a reference image or (2) a photometric algorithm that uses a statistical approach to distill each of the facial features into values for comparison with the reference image;
generating an output indicating a likelihood that the one or more of the face, the landmark, or the object matches the reference image;
determining a visual similarity between the at least one first photo and the one or more second photos based on the recognition algorithm and the output; and
performing or suggesting one or more actions to one or more second photos based on one or more predetermined similarity criteria wherein the one or more actions include recommending that the performing user share the one or more second photos.

16. The system of claim 15, wherein the activity data is historical activity data.

17. The system of claim 15, wherein the activity data comprises sharing the at least one first photo.

18. The system of claim 15, wherein the activity data comprises posting the at least one first photo.

19. The system of claim 15, wherein the activity data comprises adding the at least one first photo to a photo album.

20. The system of claim 15, wherein at least one of the one or more actions comprises recommending that the performing user share the one or more second photos.
